(19) United States
(12) Patent Application Publication
(10) Pub. No.: US 2008/0174102 A1
(43) Pub. Date: Jul. 24, 2008

(54) LABELING LIQUIDS

(76) Inventors: Lance McKinnon, Memphis, TN (US); Sherri DeLashmit, Waterford, MS (US)

Correspondence Address: FISH & RICHARDSON P.C., P.O. BOX 1022, MINNEAPOLIS, MN, 55440-1022, US

(21) Appl. No.: 12/017,576

(22) Filed: Jan. 22, 2008

Related U.S. Application Data
(60) Provisional application No. 60/886,029, filed on Jan. 22, 2007.

(51) Int. Cl. B42D 15/10; G09F 3/00; B31D 1/02

(52) U.S. Cl. 283/70; 40/299.01; 216/4

(57) ABSTRACT

A method includes identifying a liquid within a vessel using an object located in the liquid that is not attached to the vessel. The object is, for example, a metal plate inscribed with an identifier, such as the name and strength of a medical solution. The plate rests against the bottom of the vessel, and the liquid is identified by reading the name through the liquid. A method of forming a label includes inscribing a metal object configured for placement within a vessel with the name and strength of a liquid medical solution, for example, laser etching a stainless steel plate. A label includes a metal plate configured for placement within a vessel and having a name and a strength of a liquid medical solution inscribed thereon. The plate includes, for example, stainless steel, and does not include an adhesive or have a fastener interface to receive a mechanical fastener.

### CROSS-REFERENCE TO RELATED APPLICATIONS

This application claims priority to U.S. Application Ser. No. 60/886,029 filed on Jan. 22, 2007, hereby incorporated by reference in its entirety.

### TECHNICAL FIELD

This description relates to labeling liquids.

### BACKGROUND

During a medical procedure, such as a surgical procedure, medications and other solutions are sometimes removed from their original containers and placed into temporary containers, which may be disposable or reusable. For example, stainless steel containers such as cups, bowls, basins and trays are commonly used to contain medications and other solutions during surgical procedures. Stainless steel containers are routinely reused after being sterilized, for example, using high-temperature, high-pressure sterilization procedures that are common in the medical field.

In order to reduce the risk of errors resulting from the use of unlabeled, temporary containers during surgical or other medical procedures, the Joint Commission on Accreditation of Healthcare Organizations (JCAHO), which promulgates the National Patient Safety Goals (NPSG), in 2006 added new requirement 3D:
Label all medications, medication containers (e.g., syringes, medicine cups, basins), or other solutions on and off the sterile field in perioperative and other procedural settings.

The JCAHO 2006 Implementation Expectations for requirement 3D included the following:
Medications include any prescription medications; sample medications; sample medications; herbal remedies; vitamins; nutriceuticals; over-the-counter drugs; vaccines; diagnostic and contrast agents used on or administered to persons to diagnose, treat or prevent disease or other abnormal conditions; radioactive medications; respiratory therapy treatments; parenteral nutrition; blood derivatives; intravenous solutions (plain, with electrolytes and/or drugs), and any product designated by the Food and Drug Administration (FDA) as a drug. Solutions include chemicals and reagents such as formaline, saline, sterile water, Lugol's solution, radiopaque dyes, glutaraldehyde and chlorhexidine.
Medications and solutions both on and off the sterile field should be labeled even if there is only one medication being used.
Labeling occurs when any medication or solution is transferred from the original packaging to another container.
Labels include drug name, strength, amount (if not apparent from the container), expiration date when not used within 24 hours, and expiration time when expiration occurs in less than 24 hours.

To meet requirement 3D, it is known to apply adhesive labels to the outer surface of temporary containers.

### SUMMARY

According to one general aspect, a method includes identifying a liquid, for example, a medical solution, within a vessel using an object located in the liquid that is not attached to the vessel.

Implementations of this aspect may include one or more of the following features. The method includes placing the object, for example, a metal or plastic plate, in the vessel. The object is inscribed with an identifier, for example, the name of the medical solution and the strength of the medical solution. The method includes reading the name through the liquid. The object is preferably made from a substantially noncorrodible material that is more dense than water such that the object rests against the bottom of the vessel. The object can be made from, for example, stainless steel or polyethylene.

According to another general aspect, a method of forming a label includes inscribing an object configured for placement within a vessel with a name of a liquid medical solution and a strength of the solution.

Implementations of this aspect may include one or more of the following features. The object is made from, for example, a metal such as stainless steel or a plastic such as polyethylene. The object is preferably made from a substantially noncorrodible material that is more dense than water. The object is inscribed by laser etching.

According to another general aspect, a label includes a plate configured for placement within a vessel. The plate has the name and the strength of a liquid medical solution inscribed thereon.

Implementations of this aspect may include one or more of the following features. The plate is not configured for attachment to the vessel, does not include an adhesive, and is not configured to receive a mechanical fastener. The name and the strength are laser etched on the plate.

Advantages may include one or more of reducing the risk of errors during surgical and other medical procedures by providing for identification of medications and other solutions the have been removed from their original containers and placed in other containers; allowing resterilization of reusable temporary containers used during surgical and other medical procedures without risk of leaving a residue on the containers; facilitating temporary identification of a variety of medications and medical solutions stored in reusable containers during surgical and other medical procedures; allowing resterilization and reuse of labels for containers used during surgical and other medical procedures; reducing the setup time before and the cleanup time after medical procedures; and decreasing the cost of medical care by reducing or eliminating the need for sterile marking pens and disposable sterile labels, which are often discarded after a single use.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A-C are perspective views of labels identifying medical solutions.

FIG. 2A is a plan view of a label for identifying a medical solution.

FIG. 2B is a side view of the label of FIG. 2A.

FIG. 2C is an elevation view of the label of FIG. 2A.

FIG. 3 is a perspective view of another implementation of a label identifying a medical solution.

### DETAILED DESCRIPTION

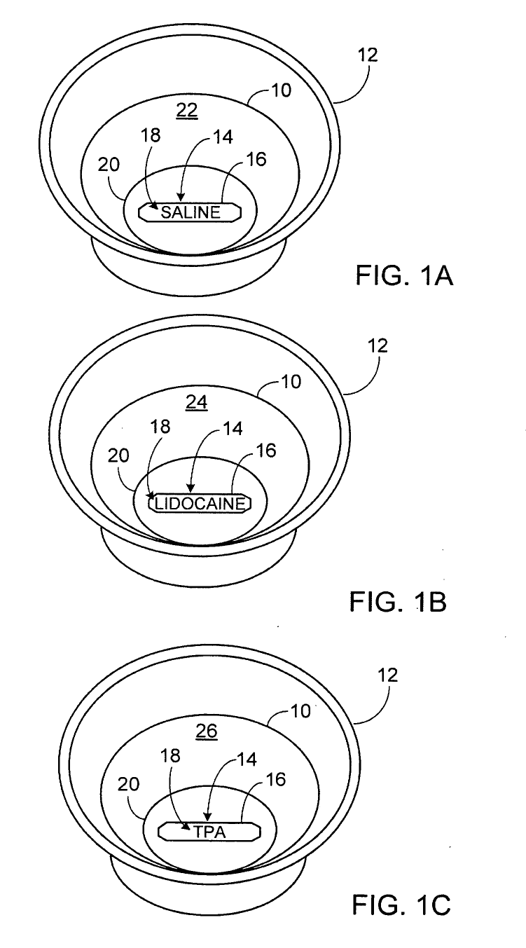

As illustrated in FIGS. 1A, 1B and 1C, during a surgical procedure, to identify medical solutions 10 contained in vessels 12, each vessel 12 is labeled by placing an object 14, for example, a metal, plate-shaped label 16, in the vessel 12 within the solution 10. The object 14 is inscribed with an identifier 18 such as the name of the medical solution 10 in the vessel 12. Operating room personnel can identify the solution 10 within the vessel 12 by reading the label 16, which is visible through the solution 10. The object 14 is not attached to the vessel 12, but merely rests against the bottom 20 of the vessel 12. After the procedure, the labels 16 can be removed from the vessels 12 and sterilized for reuse.

The labels 16 are used to identify medical solutions 10, including medications and other solutions used in perioperative and other procedural settings, as well as other medical containers. For example, the labels 16 are used to identify medical solutions 10 during surgical and other medical procedures in operating rooms, hospital emergency rooms and catheterization laboratories. In FIGS. 1A, 1B and 1C, respectively, the labels 16 identify a saline solution 22; a common local anesthetic, lidocaine 24; and a common thrombolytic agent, TPA 26 (tissue plasminogen activator, tPA or PLAT). Examples of other common medical solutions 10 include adenosine, aminophylline, diltiazem (e.g., Carizem®), chlorahexicine, contrast, heparinized saline, heparin, norepinephrine (e.g., Levophed®), morphine sulfate, nicardipine, nitro, povidone iodine, prep solution, saline, specimen, sterile water (H₂O), verapamil, midazolam (e.g., Versed®), and the like.

Thus, the labels 16 aid in compliance with the National Patient Safety Goals (NPSG) promulgated by the Joint Commission on Accreditation of Healthcare Organizations (JCAHO). In particular, the labels 16 facilitate compliance with JCAHO NPSG Requirement 3D regarding the labeling of medications, medication containers, or other solutions on and off the sterile field in perioperative and other procedural settings.

The labels 16 can be used to identify both sterile and nonsterile medical solutions 10. In addition, the labels 16 can be used to identify other liquids, including any liquid that is sufficiently transparent to permit viewing of the label 16 through the liquid.

Generally, the labels 16 are used in vessels 12 used to temporarily hold medical solutions 10 during surgical or other medical procedures. Typically, the solutions 10 are removed by a physician or by a medical technician from their original containers in preparation for or during a procedure, and are placed in vessels 12 to facilitate ready access during the procedure. The vessels 12 often are sterilized and contain sterile solutions 10. In order to permit repeated sterilization and reuse, the vessels 12 can be made from a durable, corrosion-resistant material such as stainless steel.

Furthermore, the labels 16 can be used in combination with a variety of medical containers or vessels 12, such as bowls, basins, cups and trays. In general, the labels 16 are used with any suitable vessel 12 that permits viewing of the label 16 through a contained liquid, including open-faced vessels, vessels having a lid that can be removed or displaced, transparent vessels, and the like.

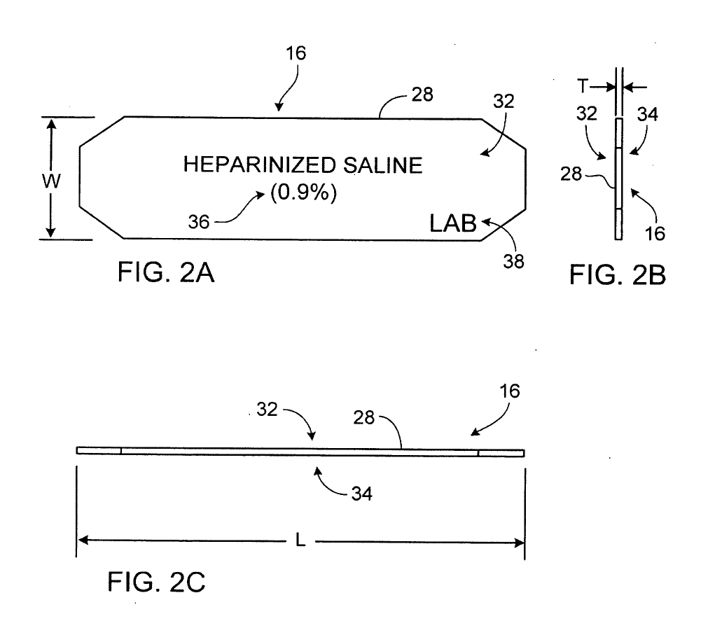

As shown in FIGS. 2A, 2B and 2C, one implementation of the label 16 is a plate 28 having dimensions that make the label 16 convenient to handle and that allow the label 16 to lie in the bottom of the vessel 12. For example, the plate 28 can have a width W of between about ¼ inch and 10 inches, a length L of between about ¼ inch and 10 inches, and a thickness T of between about 0.015 inch and 0.030 inch.

The plate is made of metal, for example, stainless steel. As a result, the label 16 is durable and corrosion resistant, permitting the label 16 to be used in a variety of solutions 10, including corrosive solutions, and repeatedly sterilized for reuse by way of a high-pressure, high-temperature process such as autoclaving. The name 30 of a particular solution 10 (“HEPARINIZED SALINE” in the example of FIG. 2) is permanently inscribed on two opposing surfaces 32, 34 of the plate 28, for example, by laser etching. The strength 36 of the solution 10 (0.9% in the example of FIG. 2) is also inscribed on the two opposing surfaces 32, 34 of the plate 28.

The solution 10 in the vessel 12 is uniquely identified by the name 30 and the strength 36 inscribed on the label 16, which is visible through the solution 10 in the vessel 12 (see FIG. 1) regardless of which of the two surfaces 32, 34 lies against the bottom 20 of the vessel 12. The font style and size of the name 30 and strength 36 of the solution 10 is selected to be legible through the liquid, which generally magnifies the inscription, making it easier to read. Thus, for example, in order to identify the solution 10, a physician or medical technician need only read the name 30 and strength 36 of the solution 10 on the label 16 lying at the bottom 20 of the vessel 12 within the solution 10. In addition, other identifying indicia 34, such as the name of a laboratory or hospital, is inscribed on the surface of the plate 28. In various implementations, the identifying indicia 34 includes either graphics or text, or both.

The label 16 need not include any attachment interface, and preferably is not attached to the vessel 12 by fasteners or an adhesive, facilitating placement in and removal from the vessel 12. For example, the plate 28 need not be drilled or punched with holes to receive rivets or other fasteners. Nor does the plate 28 need to be coated with an adhesive, such as a pressure sensitive adhesive. Thus, the plate 28 simply rests on an inner surface of the vessel, such as the bottom 20 of the vessel 12.

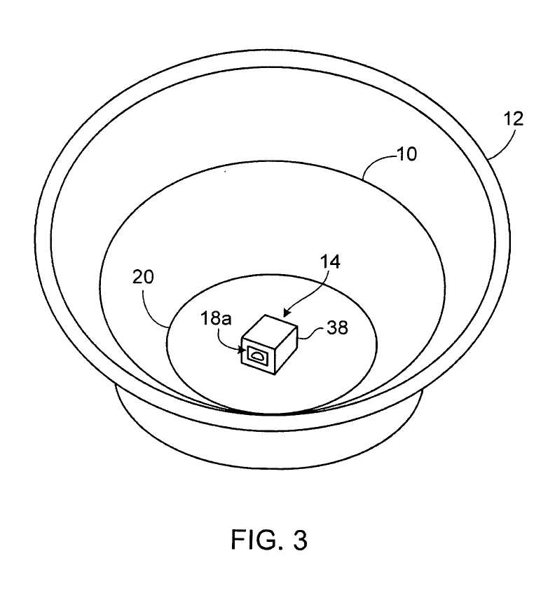

Other embodiments are within the scope of the following claims. For example, referring to FIG. 3, the object 14 shown resting at the bottom 20 of the vessel 12 in the solution 10 is a stainless steel cube 38 inscribed with an identifier 18a in the form of a symbol. In other embodiments, the object 14 can have any suitable shape or form that permits the identifier 18 to be viewed through the solution 10. In addition, the object 14 can be any suitable size that can fit within an intended type of vessel 12.

In addition, the object 14 can be made from another metal, such as aluminum, titanium, cobalt chrome (CoCr), rhodium, silver, platinum, tantalum, alloys of these metals, or Trabecular Metal™. Alternatively, the object 14 can be made from a durable plastic that can withstand repeated sterilizations, such as polyethylene, from a ceramic material, or from any suitable, substantially noncorrodible material that is more dense than the solution 10 or other liquid.

Furthermore, the identifier 18 can be inscribed using another technique, such as acid etching or engraving. The identifier 18 can be inscribed on one surface only or, where the object 14 has multiple facets of sufficient size, the identifier 18 can be inscribed on multiple surfaces.

Moreover, in some implementations the identifier 18 is not inscribed on the object. For example, the identifier 18 can be the shape or form of the object 14, the color of the object 14, a design on the object 14, or the like. Likewise, different types of identifiers 18 can be implemented in combination, such as the color and shape of the object 14.

Referring generally to FIGS. 1-3, in use, a physician or medical technician lays, or places, the object 14 in a vessel 12 and introduces the solution 10 into the vessel, covering the object 14. Alternatively, the solution 10 can be introduced into the vessel 12 and the object 14 subsequently placed in the vessel 12. The solution 10 in the vessel 12 is then used in a procedure, such as a surgical or other medical procedure. Before, during and after the procedure, the same or another person views or reads the identifier 18 to identify the solution 10.

Rather than inscribing the identifier, for example, by laser etching, the identifier can by ink printed using a medical grade ink such as Union Ink or Nazdar Ink. Furthermore, the identifiers can be color-coded according to, for example, The International Standard for User Applied Labels in Anaesthesia and Critical Care.

It will be understood that various modifications may be made. For example, useful results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A method comprising:
identifying a liquid within a vessel using an object located in the liquid that is not attached to the vessel.

2. The method of claim 1, further comprising placing the object in the vessel, the object being inscribed with an identifier of the liquid.

3. The method of claim 2, wherein placing the object comprises placing a metal plate inscribed with the identifier.

4. The method of claim 2, wherein placing the object comprises placing a plastic plate inscribed with the identifier.

5. The method of claim 2, wherein the object is inscribed with a name of the liquid.

6. The method of claim 5, wherein identifying the liquid comprises reading the name through the liquid.

7. The method of claim 1, wherein identifying the liquid comprises identifying a medical solution.

8. The method of claim 7, wherein the object is inscribed with a strength of the solution.

9. The method of claim 1, wherein the object rests against a bottom of the vessel.

10. A method of forming a label, comprising:
inscribing an object configured for placement within a vessel with a name of a liquid medical solution and a strength of the solution.

11. The method of claim 10, wherein the object comprises a metal.

12. The method of claim 10, wherein inscribing comprises laser etching.

13. The method of claim 10, wherein the object comprises a plastic.

14. A label comprising:
a plate configured for placement within a vessel and having a name and a strength of a liquid medical solution inscribed thereon.

15. The label of claim 14, wherein the plate is not configured for attachment to the vessel.

16. The label of claim 14, wherein the plate does not include an adhesive.

17. The label of claim 14, wherein the plate is not configured to receive a mechanical fastener.

18. The label of claim 14, wherein the plate comprises a substantially noncorrodible material that is more dense than the liquid medical solution.

19. The label of claim 14, wherein the plate comprises stainless steel.

20. The label of claim 14, wherein the plate comprises polyethylene.
